(19) United States
(12) Patent Application Publication
(10) Pub. No.: US 2009/0003737 A1
(43) Pub. Date: Jan. 1, 2009

(54) Flexible Receptacle for Liquids and Method of Manufacturing Thereof

(75) Inventor: Eric Risgalla, Monte Carlo (MC)

Correspondence Address: BAKER & DANIELS LLP, 300 NORTH MERIDIAN STREET, SUITE 2700, INDIANAPOLIS, IN, 46204, US

(73) Assignee: Pepup S.A., Geneva (CH)

(21) Appl. No.: 12/087,621

(22) PCT Filed: Dec. 15, 2006
(86) PCT No.: PCT/IB2006/003924

§ 371 Date: Jul. 10, 2008

(30) Foreign Application Priority Data
Jan. 13, 2006 (EP) 06405012.3

(51) Int. Cl. B65D 33/28; B29D 23/00

(52) U.S. Cl. 383/74; 428/35.2

(57) ABSTRACT

A flexible receptacle for liquid, comprising two walls (15,16) of a flexible material, the superimposed free borders of the said walls being joined by a peripheral weld seam (2) in order to define a sealed internal volume of the said receptacle, a self-sealing pouring nozzle (3) in a corner of said receptacle comprising a spout (4) located towards the outside of the said receptacle, an outlet channel (5) connecting the spout to the internal volume of the said receptacle, a self-closing valve comprising one or more obstacles (6) formed by welding of the two walls and arranged in the said internal volume essentially opposite and close to the channel leading to the spout so as to limit the cross-section of the flow-passage of the liquid between the internal volume and the outlet channel, leaving free at least one narrow channel, wherein the outlet channel is formed by a weld either side of the channel within the volume defined by the peripheral seam, said peripheral seam has a parallelogram shape having an acute angle of less than 80°, and the pouring nozzle is positioned in a corner of the said receptacle with an acute angle.

The present invention concerns a flexible receptacle for liquids, equipped with a self-closing pouring spout, and a process for the manufacture of thereof.

Flexible receptacles to contain a drink or other liquid have several advantages in relation to rigid receptacles, and in particular a lower production cost, minimal use of materials, and a low volume after use. However once open, and in the absence of a separate rigid pouring nozzle, welded or glued to the flexible sheets of the receptacle, these receptacles cannot be re-closed easily, and tend to allow the liquid to escape. The user is therefore obliged to hold the receptacle once it has been opened, since it cannot be placed on a table or other surface before it has been completely emptied, in order to avoid accidental leaks.

Various flexible receptacles with self-closing spouts have been proposed in order to remedy this problem. For example, patents GB 769810 and U.S. Pat. No. 4,988,016 propose a self-closing spout in which a resistance to the passage of the liquid is created by equipping the receptacles with long, thin channels communicating with the spout, thus developing a high resistance to the flow. In these systems, the self-closing action depends essentially on the elasticity characteristics of the material constituting the receptacle, on the dimensions of the spout, and on the characteristics of the liquid.

As another example, U.S. Pat. No. 5,411,178, proposes a receptacle in which a self-closing effect is created by a narrowing or other obstacle close to the spout, thus developing a high resistance to the passage of the liquid. Further, the patent GB 867329 describes receptacles having a self-closing spout in which a resistance to the passage of the liquid is provided by a narrowing or obstacle close to the spout such that a high resistance to liquid flow is developed dependant on the viscosity and surface tension of the filling liquid, in conjunction with the size of the passage. In systems that depend on a high local resistance, such as those described in U.S. Pat. No. 5,411,178 and GB 867329, the self-closing action depends greatly on the dimensions of the passage as well as characteristics of the liquid, and in particular on its surface tension.

In all these earlier solutions, in order to achieve a reliable self-closing effect, it is necessary to have a large resistance in the outlet channel that strongly limits the rate of flow, and requires the user to apply a strong squeezing pressure in order to empty the receptacle. Moreover, after a first use of the receptacle, the self-closing action tends to diminish, leading to unwanted leakage. Another disadvantage is that in these systems, a given spout geometry is often usable only for one specific liquid, since the self-closing effect is sensitive to variations in the dimensions of the channel or the narrowing.

Other known closure solutions are based on the creation of folds after using the receptacle, as described in American U.S. Pat. No. 3,278,085, U.S. Pat. No. 5,228,782 and U.S. Pat. No. 6,244,468, and in GB 1296216. These solutions have the disadvantage not being self-closing, and require certain operations by the user.

One self-closing solution is proposed by patent WO 2004/087526. This patent describes a flexible receptacle that includes two sheets of a flexible material, that are superimposed and assembled by a weld seam or by gluing, in order to form a sealed inner volume. The spout of the receptacle projects outward on a portion of the edge of the receptacle, and is connected to the internal volume of the receptacle by an outlet channel. The receptacle contains one or more obstacles, formed by welding or gluing of the two walls, formed in the internal volume close to the channel leading to the spout, so as to limit the cross-section of the flow passage of the liquid between the internal volume and the output channel. When the receptacle is filled with a liquid, a portion of surface that includes the spout, and bordered by the obstacle and by folds oriented essentially transverse to the obstacles, arches and creates a valve that blocks the flow of the liquid through the spout. In order to allow the liquid to flow, the user applies pressure to the receptacle in a direction essentially perpendicular to the plane of the obstacle weld, which has the effect of reducing the arching and the folds, and of increasing the pressure on the liquid in the receptacle, enabling the liquid to flow. WO 2004/087526 is included herewith by reference.

In order to meet the needs of the emerging market, there is a demand for practical and economic self-closing flexible receptacles made from a low-cost and widely-available material.

One objective of the invention is therefore to provide a flexible receptacle for liquid, that is self-closing, economical, and simple to manufacture.

It is advantageous to provide a self-closing receptacle which can be made from a very flexible and low-cost material.

It is also advantageous to provide a self-closing receptacle using a process that is respectful toward the environment.

Objectives of the invention are attained by a flexible receptacle as described in claim 1.

In the present invention, a flexible receptacle for liquids includes two walls of a flexible material, joined together by a peripheral weld seam or by gluing, in order to form a sealed internal volume of the said receptacle, a self-sealing pouring nozzle in a corner of said receptacle comprising a spout located towards the outside of the said receptacle, and an outlet channel connecting the spout to the internal volume of the said receptacle formed by a weld seam on either side of the channel flow-passage, within the volume defined by the peripheral seam. The peripheral seam of the receptacle of this present invention is in the general shape of a parallelogram having an acute angle of less than 80°, and the pouring nozzle is formed by welding or gluing in a corner of the receptacle with an acute angle.

Advantageously, the receptacle includes one or more obstacles formed by welding or gluing of the two walls and arranged in the said internal volume essentially opposite and close to the channel leading to the spout, so as to limit the cross-section of the flow-passage of the liquid between the internal volume and the outlet channel, leaving free at least one narrow channel.

The internal angle of the corner with the acute angle can be between 50° and 80°, and preferably between 60° and 75°.

Advantageously, the general parallelogram shape of the receptacle according to the invention allows one corner of the said receptacle to act as the pouring nozzle, while also performing the self-closing function in an efficient and reliable manner, without requiring any cutting of the walls for the formation of the pouring nozzle. The receptacle according to the invention can thus be manufactured from very flexible polymer sheets, conventionally used for the manufacture of flexible receptacles, of rectangular shape, and economical, with no wastage of materials, using known processes for welding and separation of successive receptacles, from continuous sheets of flexible material on the production line. In particular, one avoids problems associated with the cutting out of very flexible materials which, because of their very high plastic deformation, require very accurate mechanical tools or other cutting resources incorporated into a non-standard production line, thus increasing the production cost.

The receptacle according to the invention can therefore be manufactured from extruded polymer, conventionally used, amongst other things, in the food industry to contain liquid foods, for example polyethylene or polyvinyl chloride.

Objectives of the invention are also attained by a process for the manufacture of self-closing flexible receptacles according to claim 8.

In the present invention, a process for the manufacture of a flexible, self-closing receptacle for liquids comprises the following characteristics:

i) superimposition of two sheets of flexible material or the folding onto itself of one sheet of flexible material in order to form two walls of the said receptacle,

ii) welding of the two walls to form a weld seam defining a peripheral border of the receptacle having a parallelogram shape with an acute angle of less than 80°,

iii) welding of a pouring nozzle located in a corner of the receptacle with an acute angle, having a spout located towards the outside of the said receptacle, and an outlet channel connecting the spout to the internal volume of the said receptacle wherein the outlet channel is formed by welding a seam on either side of channel within the volume defined by the peripheral seam, and

iv) welding of one or more obstacles positioned in the said internal volume essentially opposite and close to the channel leading to the spout, so as to limit the cross-section of the liquid flow-passage between the internal volume and the outlet channel, leaving free at least one narrow channel.

Advantageously, the process described allows the simultaneous or continuous manufacture of several flexible receptacles for liquids. These flexible receptacles can be produced from a long sheet of flexible material.

The receptacle according to the present invention is of very simple construction and manufacture, without requiring any cutting of the flexible walls around the pouring nozzle to form the latter. One can therefore use very flexible and economical materials for the manufacture of the receptacle. Secondly, this reduces the quantity of material used to a minimum, which has a positive ecological impact.

Other objectives and advantageous aspects of the invention will be clear from the claims and from the description, as well as from the appended drawings, in which:

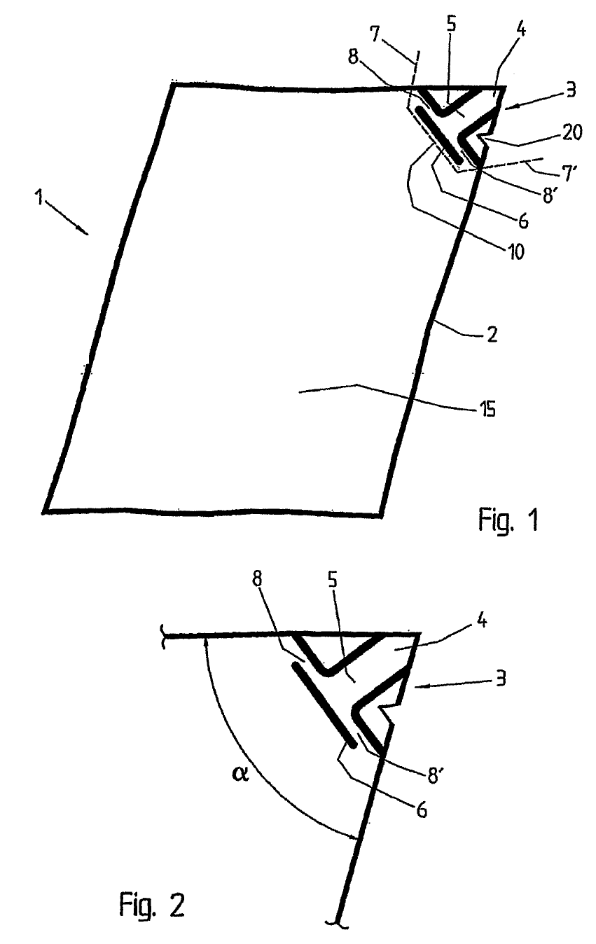

FIG. 1 is a plan view of a receptacle according to the invention;

FIG. 2 is a plan view of one part of the receptacle of the previous figure;

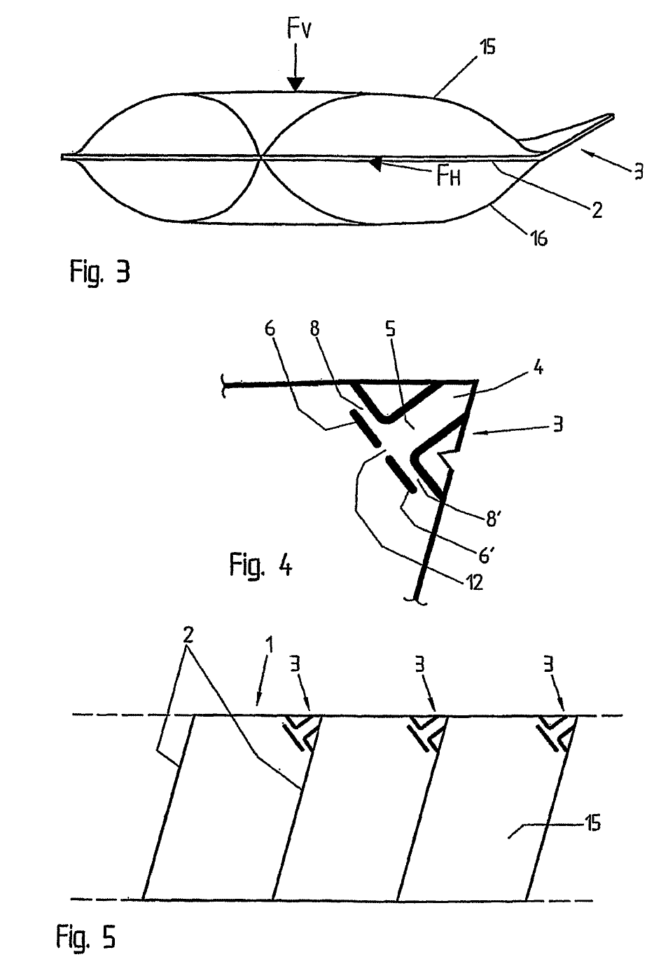

FIG. 3 is a view in perspective of the receptacle of the previous figure;

FIG. 4 is a plan view of a receptacle according to a second embodiment of the invention; and

FIG. 5 is a plan view of a series of receptacles manufactured from a sheet of flexible material, according to the invention.

Referring to FIG. 1, a receptacle 1, according to one embodiment of the invention, includes two walls of flexible material 15, 16, connected together by welding or assembled by gluing 2, forming the outline of the receptacle 1. The two walls of the receptacle are advantageously formed from one sheet of flexible material folded onto itself in order to form the two walls. The two walls can also be formed from two separate sheets of flexible material.

The assembly seam 2, in the form of a weld, also delimits a pouring nozzle 3 located in a corner of the receptacle with an acute angle. Thus the pouring nozzle is formed from the same sheet of flexible material as the sheet constituting the receptacle 1. The pouring nozzle includes a spout 4 located towards the outside of the receptacle, and an outlet channel 5 opening into the inside of the flexible receptacle 1. The pouring nozzle 3 can also include a tear leader 20, that can be used to detach a portion of the container, thus opening the spout 4 and the channel 5 respectively.

The flexible material can be, for example, a polymer material, for example a plastic such as a heat-deformable plastic, including polyethylene, polypropylene, polyvinyl chloride and polyester polymers or a mixture of polymers. Advantageously, a low-cost material, for example, a co-extruded material, can also be used.

The internal angle α of the corner of the receptacle with an acute angle shown in FIG. 2 can be between 30° and 88°, for example between 50° and 80°, advantageously between 60° and 75°, for example about 70°. The acute angle of the receptacle allows a pouring nozzle to be provided which has an efficient self-closing function, a very simple construction and manufacturing process, without requiring any cutting of the flexible walls for formation of the pouring nozzle.

An internal angle α of between about 60° and 75° may advantageously be used as providing an efficient self-closing function whilst allowing the provision of a receptacle having an advantageous volume to surface area ratio, thus optimising the use of raw materials.

In a preferred embodiment of the invention, the receptacle includes a self-closing spout such as that shown in FIGS. 1 to 4.

Advantageously, the two walls 15, 16, are welded or glued together inside the flexible receptacle 1, close to the location at which the channel 5 opens into flexible receptacle so as to form an obstacle 6 located opposite the outlet channel. The welded obstacle 6 is elongate in shape and extends between two ends which overlap with a portion the border weld 2 on either side of the outlet channel 5, leaving free two passages 8, 8′ in the direction of the channel 5. The length of the overlap is relatively small in relation to the total length of the border weld 2, preferably less than 10%. Preferably, the elongate obstacle extends essentially parallel to the parts of the border weld 2 on either side of the outlet channel, and approximately perpendicular to the general direction of the channel.

The channel (5) may have a width of for example between 5 mm and 20 mm, preferably between 10 mm and 15 mm, for example about 12 mm.

During the filling of the receptacle 1, the large central part of the two walls 15 and 16 forming the receptacle 1 separate and inflate via a filling spout (which is not shown and closed off permanently on completion of the filling process), as can be seen in FIG. 3.

During the filling of the receptacle 1, respectively during the inflation of the walls 15 and 16, two folds are created on each of the walls across the narrow passages 8 and 8′, approximately along the axes marked 7, 7′ in FIG. 1. The deformation of the walls 15 and 16 close to the ends of the obstacle 6, respectively of the two portions close to each wall 15 and 16 on either side of the shrunken passages 8 and 8′, create a fold approximately along axes 7 and 7′.

The folds 7 and 7′, as well as the generally elongate obstacle 6 lying approximately along the dashed line of the pinched area 10 shown in FIG. 1, with the section of seam 2 that lies between the fold lines 7, 7′, form a portion of surface which tends to curve inward (arch), as shown in FIG. 3. The arching of the zone between the folds 7, 7′, that includes the pouring nozzle, has the effect of pressing the two flexible sheets in this zone against each other and thus forms a valve that blocks the flow of the liquid through the passages 8, 8′ and through the orifice of the spout 4.

When the flexible receptacle is placed on a flat surface, as shown in FIG. 3, and a vertical force Fᵥ is applied approximately on the large central part of the upper wall 15, then the folds 7, 7′ and the arching effect of the zone between the folds 7, 7′, that includes the pouring nozzle, tends to become more pronounced, thus increasing the effectiveness of the valve action.

The accentuation of the folds 7, 7′ close to the passages 8, 8′ as well as the increase in the arching of the zone between the folds 7, 7′, with the application of a force Fᵥ essentially perpendicular to the plane of the flexible walls, effectively prevents liquid leakages when the flexible receptacle is placed in its natural position on an essentially flat surface, and even when another object is placed on the top of the receptacle, increasing the pressure in the receptacles.

In order to allow the flow of liquid via the spout 4, it is sufficient that the user applies a certain pressure to the receptacle, in particular by squeezing it, at least in part, in a direction Fₕ essentially perpendicular to the plane of the obstacle weld 6, thus partially opening the lips closing off the narrow passage or passages 8, 8′. The release of this squeezing action re-closes the shrunken passages and re-closes the receptacle.

The squeezing of the receptacle in direction F_{H}, essentially perpendicular to the plane of the obstacle weld, has the effect of reducing the arching and the folds 7, 7′, while at the same time increasing the pressure of the liquid in the receptacle, which then causes the lips of the flexible sheets at the entrance of passages 8 and 8′ to partially open, allowing the liquid to flow out. In fact, when a squeezing force F_{H} is applied approximately on lateral sections of the weld seam, accompanied by the increase of pressure inside the receptacle, then a traction force F_{T} and a rotation torque F_{R} act on the part of the seam close to the spout, which tends to flatten, that is say, to reduce the arching of the zone of the pouring nozzle between the folds 7, 7′.

The generally parallelogram shape of the receptacle with the aforementioned internal angle α, of the corner with an acute angle, enables the traction force and the rotation torque created by squeezing the receptacle in direction Fₕ, essentially perpendicular to the plane of the obstacle weld 6, to be optimised thus facilitating the flow of the liquid via the spout 4. The position of the spout in a corner with an acute angle of a diamond shape therefore allows the squeezing by the user of a central part of longitudinally opposite welds of the receptacle, and the creation of an effective opening of the channel, allowing the easy flow of the liquid contained in the receptacle.

As the shrunken passages 8, 8′ are very short and have a very simple geometry, the operation of the closure is less dependent on the properties of the liquid and the elasticity of the material constituting the pack than in other types of flexible receptacle. A particular flexible pack can also contain any sort of liquid, without considering in this case the chemical compatibility of the liquid with the material constituting the receptacle.

The embodiment of the flexible receptacle shown and described here includes an obstacle 6 which defines two narrow passages 8 and 8′. It would equally be possible to provide a contact between one end of the obstacle and the portion nearest to the weld 2, thus leaving only a single narrow passage, with only a single fold then being formed on the walls 15 and 16 during filling of the receptacle.

In another embodiment, shown in FIG. 4, the welded obstacle 6′ is located opposite the spout as in the previous forms of execution, except that this obstacle is in two parts and has with a central passage 12. In this form of execution, the central passage 12 created in the welded obstacle allows the flow of the liquid in the passage of the spout to be increased when the user applies pressure to the receptacle in a direction essentially perpendicular to the plane of the weld of the obstacle.

The figures show a receptacle 1 composed of a single sheet of flexible material folded onto itself along a rectilinear edge. The receptacle 1 as shown has a weld seam along its four edges to form the internal volume of the receptacle. It is understood that the weld along the rectilinear edge can be omitted. Alternatively, the receptacle can be made from two sheets of flexible material connected together by an assembly seam in the form of gluing or welding.

Advantageously, a multiplicity of receptacles 1 can be manufactured simultaneously or continuously from a long sheet of flexible material. FIG. 5 shows a series of receptacles 1 made from a sheet of flexible material. According to the form of the invention represented in FIG. 1, the receptacles are formed by folding a sheet of flexible material onto itself in order to form the two walls 15, 16 of the receptacles. The sheet of folded flexible material is then welded, for example by heat welding, in order to define the border of the receptacle around the internal volume, the pouring nozzle with a spout, and an outlet channel connecting the spout to the internal volume of the receptacle and the obstacle. The receptacles can be separated from each other simply by cutting, for example by thermal cutting. The welding and cutting stages can also be carried out simultaneously.

Advantageously, the process described allows the simultaneous or continuous manufacture of a multiplicity of flexible receptacles for liquid, from a sheet of flexible material, without the creation of any material waste, which facilitates the manufacturing process and reduces the quantity of material used.

The manufacturing process is simple, requiring no relatively complex or expensive processes for cutting around the pouring nozzle. The cutting along the two rectilinear sections of the weld seam of the outer border of the receptacle is very simple and can therefore be executed rapidly, in an economical manner, by existing industrial packaging machines. Advantageously, by the use, of simple manipulations of the material, this process allows the use of very flexible and inexpensive materials.

The formation of the self-closing spout without the need for any cutting, or creation of any waste is advantageous for the use of the receptacles for applications requiring aseptic environment, as the receptacles may be produced and filled without the need for evacuation of any waste which compromise the aseptic conditions. The receptacles are thus useful for containing long conservation products such as ultra heat treated (UHT) products.

What is claimed is:

1. A flexible receptacle for liquid, comprising two walls of a flexible material, the superimposed free borders of said walls being joined by a peripheral weld seam in order to define a sealed internal volume of the said receptacle, a self-sealing pouring nozzle in a corner of said receptacle comprising a spout located towards an outside of the said receptacle, an outlet channel connecting the spout to the sealed internal volume of the said receptacle, a self-closing valve comprising one or more obstacles formed by welding of the two walls and arranged in the said internal volume essentially opposite and close to the channel leading to the spout so as to limit a cross-section of a flow-passage of the liquid between the internal volume and the outlet channel, leaving free at least one narrow channel, wherein the outlet channel is formed by a weld either side of the channel within an area defined by the peripheral seam, and wherein said peripheral seam has a parallelogram shape having an acute angle of less than 80°, and the pouring nozzle is positioned in a corner of the said receptacle with said acute angle.

2. A flexible receptacle according to claim 1, wherein it is made from a sheet of flexible material folded onto itself in order to compose said walls.

3. A flexible receptacle according to claim 1, wherein the flexible material is a polymeric material.

4. A flexible receptacle according to claim 3, wherein the polymeric material is a plastic formed by extrusion.

5. A flexible receptacle according to claim 2, wherein said receptacle is formed from one in a juxtaposed series of several receptacles by welding and thermal cutting of a sheet of flexible material.

6. A flexible receptacle according to claim 1, wherein the internal angle of the corner with an acute angle is between 50° and 80°.

7. A flexible receptacle according to claim 6, wherein the internal angle of the corner with an acute angle is between 60° and 75°.

8. A process for the manufacture of a flexible receptacle for liquid, comprising:
i) superimposing two sheets of flexible material or the folding onto itself of a sheet of flexible material in order to form two walls of the said receptacle,
ii) welding the two walls to form a weld seam defining a peripheral border of the receptacle having a parallelogram shape with an acute angle of less than 80°,
iii) welding a pouring nozzle located in a corner of the receptacle with an acute angle, having a spout located towards the outside of the said receptacle, and an outlet channel connecting the spout to the internal volume of the said receptacle wherein the outlet channel is formed by welding a seam on either side of channel within the volume defined by the peripheral seam, and
iv) welding one or more obstacles positioned in said internal volume essentially opposite and close to the channel leading to the spout, so as to limit the cross-section of the liquid flow-passage between the internal volume and the outlet channel, leaving free at least one narrow channel.

9. A process according to claim 8, in which several receptacles are manufactured from a single sheet in a juxtaposed manner, with all the receptacles being separated from each other by thermal cutting.

10. A process according to claim 9, in which the welding and cutting stages are carried out simultaneously.
